(19) United States
(12) Patent Application Publication
(10) Pub. No.: US 2026/0208221 A1
(43) Pub. Date: Jul. 23, 2026

(54) Devices, Systems, and Methods for Post-Processing of Additive-Manufactured Workpieces

(71) Applicant: Solventum Intellectual Properties Company, Maplewood, MN (US)

(72) Inventors: Korbinian Gerlach, Gauting (DE); Christian A. Richter, Feldafing (DE); Rudolf Schmid, Eichennau (DE); Stefan K. Welker, Geltendorf (DE); Bastian P. Kirchner, Fuerstenfeldbruck (DE)

(21) Appl. No.: 19/143,461

(22) PCT Filed: Dec. 19, 2023
(86) PCT No.: PCT/IB2023/062955

§ 371 Date: Jun. 26, 2025

Related U.S. Application Data
(60) Provisional application No. 63/477,695, filed on Dec. 29, 2022.

(51) Int. Cl. B05C 5/02; B05C 15/00; B05D 1/00; B05D 1/02; B24C 1/08; B24C 3/22; B29C 64/35; B33Y 40/20

(52) U.S. Cl. CPC B05C 5/02; B05C 15/00; B05D 1/002; B05D 1/02; B24C 1/08; B24C 3/22; B29C 64/35; B33Y 40/20

(57) ABSTRACT

Post-processing devices and post-processing systems are described, as are methods for post-processing additive-manufactured workpieces with said devices and systems. The post-processing device comprises a chamber comprising: an opening configured to receive a suspended build carrier for retaining a workpiece; one or more inlet configured to receive a nozzle for delivering a pressurized substance to the workpiece; and one or more vent to allow for pressure to be released from the chamber, wherein at least one inlet is located opposite the opening, and wherein the at least one inlet is configured to deliver the pressurized substance in a flow direction that opposes gravity.

### BACKGROUND

Additive-manufacturing processes, such as stereolithography, allow for swift construction of a variety of workpieces. However, surfaces on said workpieces often retain uncured or semi-cured excess build material. While curing the uncured or semi-cured excess build material via a post-curing process is acceptable for many workpieces produced in this manner, it is not desirable for workpieces that require precision, such as dental crowns. It is more suitable, yet more challenging, to remove the excess build material to achieve and/or maintain desired margins. Additional post-processing measures are often desired, such as coating and/or polishing workpieces. Each post-processing endeavor can be time-consuming.

What is needed are post-processing systems and processes for cleaning, coating, and polishing workpieces in a timely manner.

### SUMMARY

In one embodiment, a post-processing device is described. The post-processing device includes a chamber having an opening configured to receive a suspended build carrier for retaining a workpiece and one or more inlet configured to receive a nozzle for delivering a pressurized substance to the workpiece, and one or more vent to allow for pressure to be released from the chamber. At least one inlet is located opposite the opening and the at least one inlet is configured to deliver the pressurized substance in a flow direction that opposes gravity.

In one embodiment, a post-processing system is described. The post-processing system includes a post-processing device described herein, a suspended build carrier for retaining a workpiece, and a rotating drive apparatus configured to be in mechanical communication with at least a portion of the suspended build carrier.

In one embodiment, a method for post-processing a workpiece is described. The method includes providing a post-processing system described herein, rotating the suspended build carrier having the workpiece thereon, and contacting the workpiece with a pressurized substance via an inserted nozzle. The rotating of the suspended build carrier is effective to remove excess build material by centrifugal force. The contacting of the workpiece with a pressurized substance is effective to one or more of: remove excess build material via physical impact with the pressurized substance, apply a coating of the pressurized substance to the workpiece, and polish the workpiece with the pressurized substance.

### BRIEF DESCRIPTION OF DRAWINGS

FIG. 1 illustrates an example chamber of the present disclosure

FIG. 2 illustrates an example chamber of the present disclosure

FIG. 3 illustrates an example additive-manufacturing device of the present disclosure.

FIG. 4A illustrates a workpiece prior to cleaning.

FIG. 4B illustrates a workpiece after centrifugal cleaning.

FIG. 4C illustrates a workpiece after centrifugal cleaning and cleaning via contact with a pressurized substance.

FIG. 5 is a flow chart representing a method for post-processing a workpiece with a post-processing system of the present disclosure.

### DETAILED DESCRIPTION

The present disclosure is directed toward post-processing devices, systems, methods of use thereof for cleaning, coating, and/or polishing workpieces that are produced by additive-manufacturing processes. Multiple post-processing measures can be completed within a single system, thereby mitigating cumbersome post-processing steps. Furthermore, the systems described herein can be easily tailored to the type of workpiece and to the properties of the build material employed.

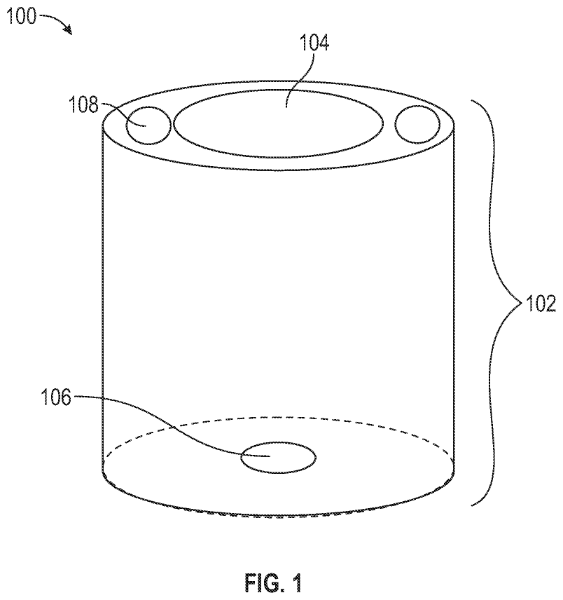

FIG. 1 is a depiction of a post-processing device 100. Post-processing device 100 includes a chamber 102 having an opening 104 configured to receive a suspended build carrier (not shown) for retaining a workpiece. Chamber 102 further includes an inlet 106 configured to receive a nozzle (not shown) for delivery a pressurized substance to the workpiece. Chamber 102 further includes one or more vent 108 to allow for pressure to be released from chamber 102. Inlet 106 is located at a base portion that is opposite to that of a base portion having opening 104. As shown, inlet 106 is oriented in such that delivery of a pressurized substance will flow in a direction that opposes gravity for the pressurized substance to contact a workpiece suspended through opening 104.

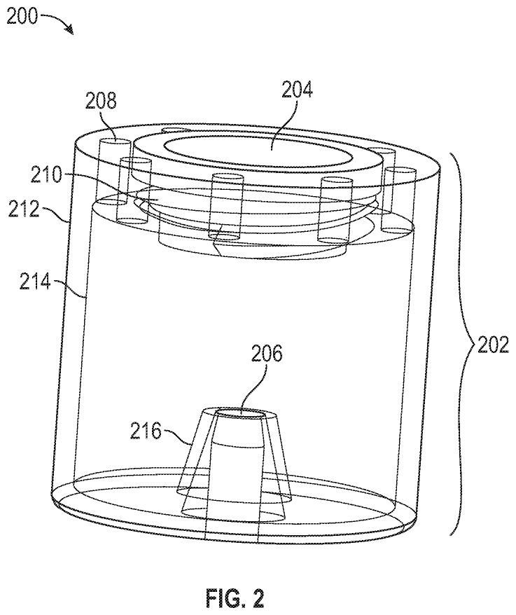

FIG. 2 is a depiction of a post-processing device 200. Post-processing device 200 includes a chamber 202 having an opening 204 configured to receive a suspended build carrier (not shown) for retaining a workpiece. Opening 204 includes a threaded body 210 for securing a suspended build carrier (having a complementary threaded portion, not shown) to chamber 202. Chamber 202 is depicted with an outer wall 212 and an inner wall 214 to form an inner chamber within (outer) chamber 202. Chamber 202 further includes one or more vent 208 to allow for pressure to be released from chamber 202. As shown, vent(s) 208 extend from outer wall 212 to inner wall 214. Likewise, threaded body 210 is shown extending from outer wall 212 to inner wall 214. Chamber 202 further includes an inlet 206 configured to receive a nozzle (not shown) for delivery of pressurized substance to the workpiece. Inlet 206 is shown within an inlet housing 216, wherein the inlet housing is of a conical shape. Inlet 206 is located at a base portion that is opposite to that of a base portion having opening 204. As shown, inlet 206 is oriented in such that delivery of a pressurized substance will flow in a direction that opposes gravity for the pressurized substance to contact a workpiece suspended through opening 204.

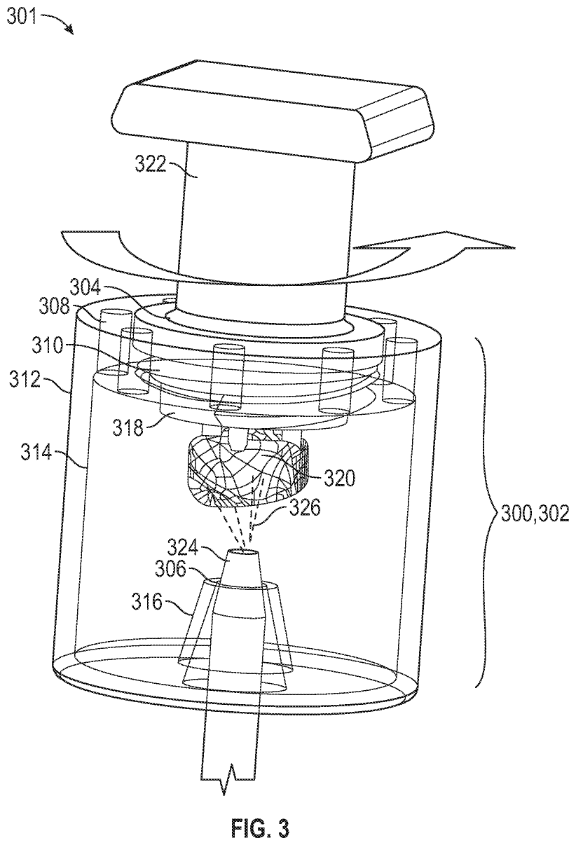

FIG. 3 is a depiction of a post-processing system 301 including a post-processing device 300. Post-processing device 300 is shown to include the features of post-processing device 200 of FIG. 2, i.e., chamber 302, opening 304 and threaded body 310, inlet 306 and inlet housing 316, vent(s) 308, outer wall 312, and inner wall 314. Post-processing system 301 further includes a suspended build carrier 318 for retaining a workpiece 320, shown to be inserted through opening 304 and secured to chamber 302 via threaded body 310. Suspended build carrier 318 is attached to a rotating drive shaft 322. Post-processing system 301 is further shown to include a nozzle 324 inserted through inlet 306 within inlet housing 316 to provide a pressurized substance 326 for contact with workpiece 320.

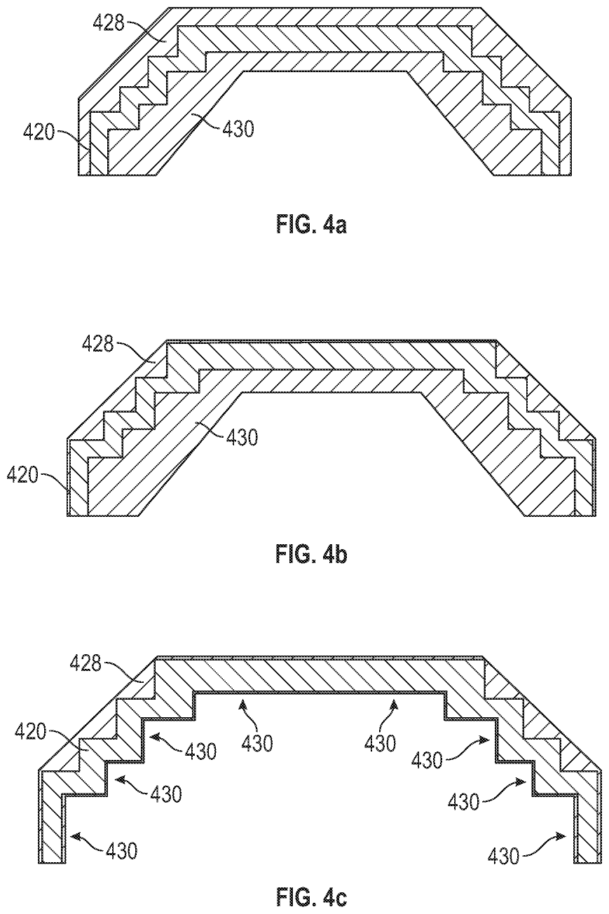

FIGS. 4A-4C are depictions of a workpiece 420 prior to cleaning, post-centrifugal cleaning, and post-centrifugal cleaning and post-pressurized substance cleaning. Workpiece 420 is shown having a curved structure.

FIG. 4A depicts workpiece 420 prior to cleaning. Excess build material 428 can be seen on an exterior portion of workpiece 420, and excess build material 430 can be seen on an interior portion of workpiece 420.

FIG. 4B depicts workpiece 420 after centrifugal cleaning (alone). Rotating workpiece 420 is effective to remove much of excess build material 428 from the exterior portion of workpiece 420. However, centrifugal cleaning is not effective to sufficiently remove excess build material 430 from the interior portion of workpiece 420, largely due to the curved nature of workpiece 420.

FIG. 4C depicts workpiece 420 after simultaneous centrifugal cleaning and pressurized-substance cleaning. Rotating workpiece 420 is effective to remove much of excess build material 428 from the exterior portion of workpiece 420 and contacting workpiece 420 with a pressurized substance (while rotating) is effective to remove much of excess build material 430 from the interior portion of workpiece 420.

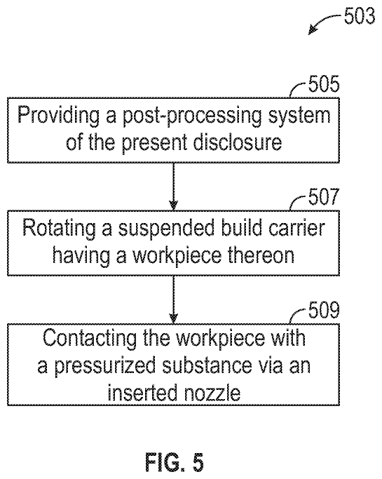

FIG. 5 is a flow chart of a method 503 for post-processing a workpiece. Method 503 includes 505 providing a post-processing system of the present disclosure. Method 503 further includes 507 rotating a suspended build carrier having a workpiece thereon, and 509 contacting the workpiece with a pressurized substance via an inserted nozzle. The workpiece is cleaned by method 503 by centrifugal force and physical impact with a pressurized substance.

### Definitions

As used herein, “about” means ±10 percent of a given value. For example, about 10 means 9 to 11.

As used herein, “additive-manufacturing” refers to a process of creating a three-dimensional object by building one layer at a time. Stereolithography is a type of additive-manufacturing that employs light for curing polymerizable resins. Data based on computer-aided design (CAD), or computer-aided manufacturing (CAM), is used to project a light pattern onto a polymerizable resin, thereby curing the polymerizable resin to produce a workpiece of a desired shape.

As used herein, “build plate” refers to at least a portion of a platform in which a workpiece is built upon via an additive-manufacturing technique.

As used herein, “build material” refers to the material used to construct a workpiece. Build materials are typically include a selection of light-curable monomers, i.e., monomers that undergo polymerization (i.e., curing) in the presence of certain wavelengths of light.

As used herein, “centrifugal force” refers to an outward force, away from the axis of rotation, acting on a revolving object. “Centrifugal cleaning” refers to removal of a substance via centrifugal force.

As used herein, “chamber” refers to an object with an enclosed space.

As used herein, “cleaning” refers to the removal of a material from a workpiece (e.g., excess build material).

As used herein, “coating” refers to a material that adheres to a surface of a workpiece.

As used herein, “dental article” means any article which is to be used in a dental or orthodontic field, e.g., dental restorations, tooth models, orthodontic devices, or the like.

As used herein, “excess build material” refers to a material used to construct a workpiece that remains on the workpiece in excess. Excess build material is uncured or semi-cured material that is not desired in the final article.

As used herein, the phrase “one or more of” such as used in the phrase “one or more of A and B” or “one or more of at least one A and at least one B” means a composition may include at least one A, more than one A, at least one B, more than one B, at least one A and at least one B, more than one A and more than one B. In other words, the phrase is not intended to mean the composition must have at least one of each of A and B.

As used herein, “polishing” refers to a smoothing of a surface.

As used herein, “post-processing” refers to actions upon a workpiece following construction of said workpiece. “Post-processing devices” or post-processing systems” refers to objects that allow for actions upon a workpiece following construction of said workpiece.

As used herein, “pressurized substance” refers to a substance that is expelled from a container under some amount of force.

As used herein, “suspended build carrier” refers to a component that retains (e.g., hangs) a workpiece.

As used herein, “vent’ refers to some area within an otherwise closed system that is open to the atmosphere.

As used herein “workpiece” refers to an article that has been produced (i.e., built) by an additive-manufacturing technique.

### Post-Processing Devices

In various embodiments, a post-processing device is described. The post-processing device may include a chamber having an opening configured to receive a suspended build carrier for retaining a workpiece. The post-processing device may further include one or more inlet configured to receive a nozzle for delivering a pressurized substance to the workpiece. The post-processing device may further include one or more vent to allow for pressure to be released from the chamber. In some embodiments, at least one inlet that may be configured to deliver the pressurized substance, in a flow direction that opposes gravity, is located opposite the opening.

In some embodiments, the chamber may be in the shape of a cylinder, a cone, a sphere, an ellipsoid, a cube, a cuboid, or any approximate shape thereof. In some embodiments, the chamber may be a cylinder characterized by a diameter of about 20 cm to about 100 cm and a length of about 30 cm to about 100 cm. For example, the chamber may be a cylinder having a diameter in cm of about 20, 25, 30, 35, 40, 45, 50, 55, 60, 65, 70, 75, 80, 85, 90, 95, or 100, or a value within a range between any of the preceding values, e.g., between about 40 and about 60, or the like. For example, the chamber may be a cylinder having a length in cm of about 30, 35, 40, 45, 50, 55, 60, 65, 70, 75, 80, 85, 90, 95, or 100, or a value within a range between any of the preceding values, e.g., between about 70 and about 90, or the like.

In some embodiments, the chamber may have an outer wall and an inner wall (i.e., double-walled). The outer wall and the inner wall may be of the same or different shape. For example, the outer wall and the inner wall may both be cylindrical in shape. In some embodiments, the inner wall may be shorter in length than the length of the outer wall. For example, the length of the inner wall may be about 50%, 55%, 60%, 65%, 70%, 75%, 80%, 85%, 90%, or 95% or 99% of that of the length of the outer wall, or a range between any of the preceding values, e.g., between about 75% and about 90%, or the like. In some embodiments, the outer wall and the inner wall may form a chamber within a chamber. In some embodiments, space between the outer wall and the inner wall may be filled with a material (e.g., insulation) or simply air, or alternatively under vacuum.

In some embodiments, the opening of the chamber may be within a top portion of the chamber (e.g., wherein the chamber is in the shape of a cylinder, e.g., the top portion being one of the cylindrical bases). In some embodiments, the opening of the chamber may extend from an outer wall to an inner wall of the chamber. In some embodiments, the opening may include a threaded body. That is, the opening may have a portion with a helical structure like that of a screw. A threaded body may allow for securing a suspended build carrier to the chamber. Alternatively, or in addition to a threaded body, the opening may have one or more securing means, e.g., clasps, clamps, buckles, pins, latches, or the like, and a combination thereof.

In some embodiments, the post-processing device may have a plurality of inlets for receiving a plurality of nozzles for delivering a variety of pressurized substances. For example, the post-processing device may include 2-6 inlets, wherein each inlet may receive a nozzle for a separate pressurized substance. The different pressurized substances may independently be for cleaning of a workpiece or coating of a workpiece. In some embodiments, the plurality of inlets may be movable such that any give inlet may be aligned with the workpiece. Movable inlets may be through mechanical or automatic means. In other embodiments, the post-processing device may have only one inlet for receiving a nozzle for delivering one or more pressurized substances. In some instances, different nozzles for different pressurized substances may be inserted into the inlet.

In some embodiments, an inlet configured to receive a nozzle for delivery of a pressurized substance may be located within an inlet housing. The inlet housing may be a protruding compartment within the chamber. The inlet housing may be of any shape, e.g., conical, cylindrical, hemispherical, or the like. In some embodiments, the inlet housing has a conical shape. In some embodiments, the inlet housing may have a means to secure a nozzle inserted therein. For example, the inlet housing may include a securing means such as a threaded portion, a clip, a latch, a securing pin, or the like.

In some embodiments, the post-processing device may include 1-10 vents, e.g., 1, 2, 3, 4, 5, 6, 7, 8, 9, 10, or a value within a range between any of the preceding values. In some embodiments, a vent may be characterized by an area size of about 4 mm² to about 100 mm². For example, a vent may be characterized by an area size in mm² of about 4, 6, 8, 10, 15, 20, 25, 30, 35, 40, 45, 50, 55, 60, 65, 70, 75, 80, 85, 90, or 100, or a value within a range between any of the preceding values, e.g., between about 8 and about 20, or the like. In some embodiments, a total number of vents may collectively be characterized by an area size of about 4 mm² to about 1000 mm². The number of vents and size of any vent may be selected to control an amount of desired pressure within the chamber upon use of the pressurized substance.

In some embodiments, a vent may be at least partly covered with a porous material. A porous material may allow for pressure release, yet trap debris from exiting the post-processing device. For example, a porous material may be selected from felt, fleece, woven or nonwoven fabric, a permeable polymeric film, a glass frit, a paper, a combination thereof, and the like. In many embodiments, the porous material may be removable and replaceable (e.g., for ease of cleaning). In some embodiments, the porous material may be located on an interior surface of the chamber. In other embodiments, the porous material may be located on an exterior surface of the chamber.

In some embodiments, one or more vent may be located on a surface within the chamber that has the opening for receiving a suspended build carrier. In some embodiments, one or more vent may be located on a surface opposite to a surface having the at least one inlet.

In some embodiments, each chamber of a doubled-walled chamber (described above) may include one or more vent extending from an inner chamber through the outer chamber.

### Post-Processing Systems

In various embodiments, a post-processing system is described. The post-processing system may include a post-processing device described herein, a suspended build carrier for retaining a workpiece, and a rotating drive apparatus configured to be in mechanical communication with at least a portion of the suspended build carrier.

In some embodiments, the post-processing system may further include one or more nozzle for delivering a pressurized substance to the post-processing device. In some embodiments, the nozzle is configured to fit an inlet housing within the chamber of the post-processing device.

In some embodiments, the suspended build carrier may include a mechanism for retaining an additive-manufacturing build plate having the workpiece thereon. In other words, a workpiece may be constructed by any conventional additive-manufacturing technique and the respective additive-manufacturing build plate may be transferred to the suspended build carrier for subsequent cleaning and/or coating of the workpiece. For example, the mechanism may include a slotted holder, a threaded component, a magnet, a clamp, a combination thereof, or the like.

In some embodiments, the suspended build carrier may include a mechanism specific for retaining a workpiece (e.g., absent the build plate). For example, the suspended build carrier may include a mechanism, such as a clamp, that is configured specifically to the workpiece, class of workpieces, or printed support structures thereof. For example, a mechanism (e.g., clamp) for retaining a molar dental crown workpiece may be configured differently than a mechanism (e.g., clamp) for retaining an incisor dental crown workpiece. In some embodiments, the mechanism for retaining a workpiece may be interchangeable. That is, different mechanisms for retaining different workpieces may be used with a single suspended build carrier.

In some embodiments, the suspended build carrier may have a threaded portion that is complementary to a threaded body within the opening of the chamber of the post-processing device, such that the suspended build carrier may be secured to the chamber.

In some embodiments, the rotating drive apparatus may be configured to rotate the suspended build carrier. In some embodiments, the rotating drive apparatus may be configured to rotate only a portion of the suspended build carrier that resides inside the chamber of the post-processing device when the post-processing system is assembled. In other embodiments, the rotating drive apparatus may be configured to rotate the suspended build carrier and at least part of the chamber (e.g., an inner chamber) of the post-processing device.

In some embodiments, the post-processing system may further include one or more nozzle. Nozzles may be configured to be secured within an inlet housing described above. Nozzles may also be selectively shaped to deliver a pressurized substance in a desired pattern that is best suited for any workpiece shape, workpiece build material, or purpose.

### Methods for Post-Processing a Workpiece

In various embodiments, a method for cleaning and/or coating a workpiece is described. The method may include providing a post-processing system described herein, rotating the suspended build carrier having the workpiece thereon, and contacting the workpiece with a pressurized substance via an inserted nozzle. Excess build material may be removed from the workpiece by centrifugal force and physical impact with the pressurized substance. A coating may be applied to the workpiece via the pressurized substance. The workpiece may be polished via the pressurized substance.

In some embodiments, the suspended build carrier may be rotated to centrifugally clean the workpiece, followed by contacting the workpiece with a pressurized substance to physically clean the workpiece. In some embodiments, the workpiece may be first contacted with a pressurized substance to physically clean, followed by rotating the suspended build carrier to centrifugally clean the workpiece. In some embodiments, the workpiece may be cleaned simultaneously via centrifugal force and physical impact with a pressurized substance.

In many embodiments, the workpiece may be an article having a portion that is at least partially hollow. In many embodiments, the workpiece may be a dental article or an orthodontic article, e.g., a crown, an implant, a bridge, a cap, a denture, an inlay, an onlay, a veneer, a facing, a coping, an abutment, a bracket, a buccal tube, a cleat, an attachment, a button, an aligner, a retainer, an indirect bonding tray, a direct bonding tray, or the like.

In some embodiments, the suspended build carrier may be rotated at a rate of about 300 rpm to about 3000 rpm. For example, the suspended build carrier may be rotated at a rate, in rpm, of about 300, 400, 500, 600, 700, 800, 900, 1000, 1200, 1500, 1800, 2000, 2200, 2500, 2800, or 3000, or a value within a range between any of the preceding values, e.g., between about 500 rpm and about 1000 rpm, or the like. In some embodiments, the rate may be selected based on one or more of the size of the chamber, the size and/or shape of the workpiece, and the viscosity of the build material of the workpiece.

In many embodiments, a pressurized substance for removing excess build material from a workpiece may be a gas, a liquid, or a combination thereof. For example, a pressurized gaseous substance for cleaning a workpiece of excess build material may be selected from air (i.e., primarily a mixture of nitrogen and oxygen gas), nitrogen gas, argon gas, and a combination thereof. For example, a pressurized liquid substance for cleaning a workpiece of excess build material may be selected from water; an organic solvent (e.g., alcohol (e.g., ethanol, isopropanol, or the like), esters (e.g., ethyl acetate, methyl butyrate, or the like), ethers (e.g., diethyl ether, methyl t-butyl ether, tetrahydrofuran, dioxane, or the like), ketones (e.g., acetone, methyl ethyl ketone, or the like), alkylhalides (e.g., chloroform, dichloromethane, or the like), alkanes (e.g., hexane, pentane, or the like), aromatics (e.g., benzene, toluene, or the like); or an aqueous solution comprising a dissolved or dispersed: salt (e.g., sodium chloride, calcium chloride, or the like), surfactant, (e.g., polysorbate, polyethylene glycol, or the like), acid (e.g., acetic acid, citric acid, or the like), base (e.g., sodium bicarbonate, sodium carbonate, borax, or the like), oxidant (e.g., hydrogen peroxide, sodium percarbonate, or the like), or a combination thereof. The pressurized substance for cleaning may be selected according to the excess build material intended to be removed. For example, a liquid pressurized substance known to dissolve the build material of a workpiece may not be suitable for said workpiece. However, the combination of rotation and use of a particular liquid substance may be suitable for cleaning certain build materials that would otherwise be unsuitable under standard cleaning conditions of soaking, wiping, or the like.

In some embodiments, a pressurized substance for removing excess build material may be delivered to a workpiece at a pressure from about 50 kPa to about 1000 kPa for a period of about 10 s to about 180 s. For example, the pressurized substance may be delivered at a pressure, in kPa, of about 50, 100, 150, 200, 250, 300, 350, 400, 450, 500, 550, 600, 650, 700, 750, 800, 850, 900, 950, or 1000, or a value within a range between any of the preceding values, e.g., between about 250 kPa and about 350 kPa. For example, the pressurized substance may be delivered for a period, in s, of about 10, 20, 30, 40, 50, 60, 70, 80, 90, 100, 110, 120, 130, 140, 150, 160, 170, or 180, or a value within a range between any of the preceding values, e.g., between about 20 s and about 60 s, or the like. An optimal pressure and exposure time may be selected based on the nature of the pressurized substance and the build material of the workpiece. For example, higher pressures and/or longer exposure times may ultimately deform some build materials.

In some embodiments, a pressurized substance for coating a workpiece may be liquid. For example, a pressurized liquid substance for coating a workpiece may be selected from a varnish, a paint, a stain, a sealant, and a combination thereof.

In some embodiments, a pressurized substance for polishing a workpiece may be a solid (i.e., a plurality of solid particles). For example, a pressurized solid substance for polishing a workpiece may be selected from sand, glass, quartz, silica, rock, gravel, salt, silt, metal particles, clay, a combination thereof, or the like. The type of pressurized solid for polishing a workpiece may be selected according to the nature of the material within the workpiece. For example, a harder solid substance may be suitable for a workpiece comprised of a harder build material whereas a harder solid substance may not be suitable for a workpiece comprised of a softer build material.

### Equivalents

Those skilled in the art will recognize, or be able to ascertain, using no more than routine experimentation, numerous equivalents to the specific embodiments described specifically herein. Such equivalents are intended to be encompassed in the scope of the following claims.

1. A post-processing device comprising:
a chamber comprising:
an opening configured to receive a suspended build carrier for retaining a workpiece;
one or more inlet configured to receive a nozzle for delivering a pressurized substance to the workpiece; and
one or more vent to allow for pressure to be released from the chamber,
wherein at least one inlet is located opposite the opening, and
wherein the at least one inlet is configured to deliver the pressurized substance in a flow direction that opposes gravity.

2.-4. (canceled)

5. The post-processing device of claim 1, the chamber having an outer wall and an inner wall.

6.-10. (canceled)

11. The post-processing device of claim 1, wherein the opening is within a top portion of the chamber.

12. The post-processing device of claim 1, wherein the opening comprises a threaded body for securing the suspended build carrier to the chamber.

13. The post-processing device of claim 1, further comprising a means for securing the suspended build carrier to the chamber.

14. The post-processing device of claim 13, wherein the means for securing the suspended build carrier to the chamber is selected from a threaded body within the opening, a clasp, a clamp, a buckle, a pin, a latch, and a combination thereof.

15. (canceled)

16. The post-processing device of claim 1, further comprising an inlet housing comprising a means for securing one or more nozzle, wherein the at least one inlet is located within the inlet housing

17.-19. (canceled)

20. The post-processing device of claim 1, further comprising a porous material at least partly covering the one or more vent.

21. The post-processing device of claim 20, the porous material comprising a fabric, a permeable polymeric film, a glass frit, a paper, or a combination thereof.

22.-23. (canceled)

24. A post-processing system comprising:
a post-processing device of a claim 1;
a suspended build carrier for retaining a workpiece; and
a rotating drive apparatus configured to be in mechanical communication with at least a portion of the suspended build carrier.

25. The post-processing system of claim 24, further comprising one or more nozzle for delivering a pressurized substance to the post-processing device.

26. The post-processing system of claim 24, the suspended build carrier further comprising a mechanism for retaining an additive-manufacturing build plate.

27. (canceled)

28. The post-processing system of claim 24, the suspended build carrier further comprising a threaded portion that is complementary to a threaded body within the opening of the chamber of the post-processing device.

29.-31. (canceled)

32. A method for post-processing a workpiece, the method comprising:
providing a post-processing system of claim 24;
rotating the suspended build carrier having the workpiece thereon; and
contacting the workpiece with a pressurized substance via an inserted nozzle,
wherein the rotating of the suspended build carrier and the contacting of the workpiece with a pressurized substance is effective to one or more of:
remove excess build material on the workpiece via centrifugal force and
physical impact with the pressurized substance;
apply a coating to the workpiece; and
polish the workpiece.

33. The method of claim 32, wherein the workpiece is a dental article.

34. The method of claim 32, wherein the workpiece is a dental article or an orthodontic article selected from a crown, an implant, a bridge, a cap, a denture, an inlay, an onlay, a veneer, a facing, a coping, an abutment, a bracket, a buccal tube, a cleat, an attachment, a button, an aligner, a retainer, an indirect bonding tray, and a direct bonding tray.

35.-36. (canceled)

37. The method of claim 32, wherein the pressurized substance is a gas selected from air, nitrogen gas, or argon gas.

38. (canceled)

39. The method of claim 32, wherein the pressurized substance is a liquid selected from water, an aqueous solution, and an organic solvent.

40. The method of claim 32, wherein the pressurized substance is a liquid selected from a varnish, a paint, a stain, a sealant, and a combination thereof.

41. (canceled)

42. The method of claim 32, wherein the pressurized substance is a solid selected from sand, glass, quartz, silica, rock, gravel, salt, silt, metal particles, clay, and a combination thereof.

43-45. (canceled)
